(19) United States
(12) Patent Application Publication
(10) Pub. No.: US 2020/0102868 A1
(43) Pub. Date: Apr. 2, 2020

(54) NOVEL TWC CATALYSTS FOR GASOLINE EXHAUST GAS APPLICATIONS

(71) Applicant: JOHNSON MATTHEY PUBLIC LIMITED COMPANY, London (GB)

(72) Inventors: Yuichi FUJIMORI, Kitsuregawa (JP); Takashi YAMADA, Kitsuregawa (JP); Tomotaka HIROTA, Kitsuregawa (JP); Kenji TANIKAWA, Kitsuregawa (JP); Shintaro SAIKI, Kitsuregawa (JP); Yoshitaka HAYASHI, Kitsuregawa (JP); Sungwook KIM, Kitsuregawa (JP)

(21) Appl. No.: 16/583,398

(22) Filed: Sep. 26, 2019

Related U.S. Application Data
(60) Provisional application No. 62/737,976, filed on Sep. 28, 2018.

(51) Int. Cl. F01N 3/10; B01J 23/42; B01J 23/46; B01J 23/44; F01N 3/28

(52) U.S. Cl. CPC F01N 3/101; B01J 23/42; B01J 23/464; F01N 2510/0682; F01N 3/2807; F01N 2370/02; F01N 2510/0684; B01J 23/44

(57) ABSTRACT

A three-way catalyst article, and its use in an exhaust system for internal combustion engines, is disclosed. The catalyst article for treating exhaust gas comprising: a substrate comprising an inlet end, an outlet end with an axial length L; an inlet catalyst layer beginning at the inlet end and extending for less than the axial length L, wherein the inlet catalyst layer comprises an inlet rhodium component and an inlet platinum component; an outlet catalyst layer beginning at the outlet end and extending for less than the axial length L, wherein the outlet catalyst layer comprises an outlet rhodium component.

### FIELD OF THE INVENTION

The present invention relates to a catalyzed article useful in treating exhaust gas emissions from gasoline engines.

### BACKGROUND OF THE INVENTION

Internal combustion engines produce exhaust gases containing a variety of pollutants, including hydrocarbons (HCs), carbon monoxide (CO), and nitrogen oxides (“NOₓ”). Emission control systems, including exhaust gas catalysts, are widely utilized to reduce the amount of these pollutants emitted to atmosphere. A commonly used catalyst for gasoline engine applications is the three-way catalyst (TWC). TWCs perform three main functions: (1) oxidation of CO; (2) oxidation of unburnt HCs; and (3) reduction of NOₓ to N₂.

In most catalytic converters, the TWC is coated onto a high surface area substrate that can withstand high temperatures, such as flow-through honeycomb monoliths. As evidenced by recent advances in TWC technology as those described in U.S. Pat. Nos. 6,022,825, 9,352,279, 9,040,003, and US Pat. Publication No. 2016/0228818, catalytic converters composed of multiple layers remain a canonical design in the application of TWC for perspicuous layout. A drawback inherent to the design, however, lies in lower sticking-coefficient of reactants onto layer(s) covered with at least another catalytic layer, for which PGMs in the covered layers are ineffectively utilized than those on the top layer. This detrimental tendency becomes more pronounced for catalytic converters where zoned PGM layers are employed. In response to an increasing demand in the reduction of PGM contents used for TWC, this invention fulfills the need to decrease the PGM contents per catalytic converter via their effective usages.

### SUMMARY OF THE INVENTION

One aspect of the present disclosure is directed to a catalyst article for treating exhaust gas comprising: a substrate comprising an inlet end, an outlet end with an axial length L; an inlet catalyst layer beginning at the inlet end and extending for less than the axial length L, wherein the inlet catalyst layer comprises an inlet rhodium component and an inlet platinum component; an outlet catalyst layer beginning at the outlet end and extending for less than the axial length L, wherein the outlet catalyst layer comprises an outlet rhodium component.

The invention also encompasses an exhaust system for internal combustion engines that comprises the three-way catalyst component of the invention.

The invention also encompasses treating an exhaust gas from an internal combustion engine, in particular for treating exhaust gas from a gasoline engine. The method comprises contacting the exhaust gas with the three-way catalyst component of the invention.

### BRIEF DESCRIPTION OF THE DRAWINGS

FIG. 1 shows a catalyst article having an inlet catalyst layer and an outlet catalyst layer. The inlet catalyst layer is fully supported/deposited directly on the substrate. The outlet catalyst layer is partially supported/deposited directly on the substrate and partially supported/deposited on the top of the inlet catalyst layer.

FIG. 2 shows a catalyst article having an inlet catalyst layer and an outlet catalyst layer. The outlet catalyst layer is fully supported/deposited directly on the substrate. The inlet catalyst layer is partially supported/deposited directly on the substrate and partially supported/deposited on the top of the outlet catalyst layer.

FIG. 3 shows a comparative commercial catalyst article having two layers on the substrate with one zone.

### DETAILED DESCRIPTION OF THE INVENTION

The present invention is directed to the catalytic treatment of combustion exhaust gas, such as that produced by gasoline engines or other engines, and to related catalytic articles and systems. More specifically, the invention relates the simultaneous treatment of NOₓ, CO, and HC in a vehicular exhaust system. The inventors have discovered a synergistic contribution from the monolayer architecture and zoned distribution of active metals that unexpectedly produces a high conversion rate for NOₓ, CO, and HC. The processes of the present invention also reduce processing time and lower costs of the catalyst.

One aspect of the present disclosure is directed to a catalyst article for treating exhaust gas comprising: a substrate comprising an inlet end, an outlet end with an axial length L; an inlet catalyst layer beginning at the inlet end and extending for less than the axial length L, wherein the inlet catalyst layer comprises an inlet rhodium component and an inlet platinum component; an outlet catalyst layer beginning at the outlet end and extending for less than the axial length L, wherein the outlet catalyst layer comprises an outlet rhodium component.

The catalyst article of the present invention can have three catalyst zones along the axis of the substrate: an upstream zone coated only with the inlet catalyst layer, a middle zone coated with both the inlet and the outlet catalyst layers, and a downstream zone coated only with the outlet catalyst layer.

The inventors have discovered a synergistic contribution from monolayer architecture of catalytic converters and zoned active metal distributions that unexpectedly produces a high conversion rate for NOₓ, CO, and HC. Among the unexpected benefits of the present invention are higher sticking coefficient of reactant molecules to active metal species compared to conventional multilayered TWC catalysts of similar concentration (washcoat loadings) and improved catalytic performance compared to conventional TWC catalyst, even when the conventional TWC is composed of higher contents of active metals. These benefits lead to improved engine performance, improved fuel economy, and lower costs.

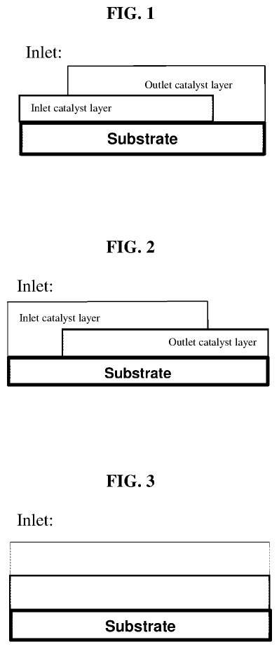

The inlet catalyst layer of the catalyst article can extend for 10 to 99 percent of the axial length L. Preferably, the inlet catalyst layer can extend for 20 to 90 percent, 30 to 80 percent, more preferably, 50 to 70 percent, of the axial length L. (E.g., see FIGS. 1 and 2).

The outlet catalyst layer of the catalyst article can extend for 10 to 99 percent of the axial length L. Preferably, the outlet catalyst layer can extend for 20 to 90 percent, 30 to 80 percent, more preferably, 50 to 70 percent, of the axial length L. (E.g., see FIGS. 1 and 2).

The total length of the outlet catalyst layer and the inlet catalyst layer can be from 90 percent to 180 percent of the axial length L. Preferably, the total length of the outlet catalyst layer and the inlet catalyst layer is from 100 percent to 160 percent of the axial length L. More preferably, the total length of the outlet catalyst layer and the inlet catalyst layer is from 110 percent to 150 percent of the axial length L.

The inlet catalyst layer can be essentially free of PGM metals other than the inlet rhodium component and the inlet platinum component.

The inlet catalyst layer can comprise up to 300 g/ft³ of the inlet platinum component. Preferably, the inlet catalyst layer can comprise 50-300 g/ft³, more preferably, 150-250 g/ft³ of the inlet platinum component.

The inlet catalyst layer can comprise up to 100 g/ft³ of the inlet rhodium component. Preferably, the inlet catalyst layer can comprise 5-80 g/ft³, more preferably, 10-50 g/ft³ of the inlet rhodium component.

The weight ratio of the inlet platinum component to the inlet rhodium component can be from 10:1 to 1:10, 5:1 to 1:5, 3:1 to 1:3, or 2:1 to 1:2.

Alternatively, the weight ratio of the inlet platinum component to the inlet rhodium component can be at least 1:5, at least 1:3, or at least 1:2.

The inlet catalyst layer can further comprise an inlet PGM component. In some embodiments, the inlet PGM component is palladium.

The inlet catalyst layer can comprise up to 300 g/ft³ of the inlet palladium component. Preferably, the inlet catalyst layer can comprise 50-300 g/ft³, more preferably, 150-250 g/ft³ of the inlet palladium component.

The weight ratio of the inlet palladium component to the inlet rhodium component can be from 100:1 to 1:10, preferred, 60:1 to 1:5, more preferably, 30:1 to 1:3.

The rhodium loading in the inlet catalyst layer can be no less than the rhodium loading in the outlet catalyst layer. The ratio of the inlet rhodium component and the outlet rhodium component can be from 20:1 to 1:1, preferably from 10:1 to 1:1, more preferably, 8:1 to 3:2, most preferably, 6:1 to 2:1.

In some embodiments, the rhodium loading in the inlet catalyst layer is greater than the rhodium loading in the outlet catalyst layer. The ratio of the inlet rhodium component and the outlet rhodium component can be at least 3:2, preferably at least 2:1, more preferably, at least 3:1.

The inlet catalyst layer can further comprise an inlet inorganic oxide material, a first inlet oxygen storage capacity (OSC) material, an inlet alkali or alkali earth metal component, and/or an inlet inorganic oxide.

The total washcoat loading of the inlet catalyst layer can be from 0.1 to 5 g/in³. Preferably, the total washcoat loading of the inlet catalyst layer is 0.5 to 3.5 g/in³, most preferably, the total washcoat loading of the inlet catalyst layer is 1 to 3 g/in³.

The first inlet OSC material is preferably selected from the group consisting of cerium oxide, zirconium oxide, a ceria-zirconia mixed oxide, and an alumina-ceria-zirconia mixed oxide. More preferably, the first inlet OSC material comprises the ceria-zirconia mixed oxide. The ceria-zirconia mixed oxide can further comprise some dopants, such as, La, Nd, Y, Pr, etc.

The ceria-zirconia mixed oxide can have a molar ratio of zirconia to ceria at least 50:50, preferably, higher than 60:40, more preferably, higher than 75:25. In addition, the first inlet OSC material may function as a support material for the inlet rhodium component.

Alternatively, the ceria-zirconia mixed oxide can have a molar ratio of zirconia to ceria from 20:1 to 1:20. In some embodiments, the ceria-zirconia mixed oxide can have a molar ratio of zirconia to ceria from 10:1 to 1:10. In further embodiments, the ceria-zirconia mixed oxide can have a molar ratio of zirconia to ceria from 5:1 to 1:1.

The inlet catalyst layer can further comprise a second inlet OSC material.

The second inlet OSC material is preferably selected from the group consisting of cerium oxide, zirconium oxide, a ceria-zirconia mixed oxide, and an alumina-ceria-zirconia mixed oxide. More preferably, the second inlet OSC material comprises the ceria-zirconia mixed oxide. The ceria-zirconia mixed oxide can further comprise some dopants, such as, La, Nd, Y, Pr, etc.

The inlet OSC material (e.g., ceria-zirconia mixed oxide), including the first and the second, can be from 10 to 90 wt %, preferably, 25-75 wt %, more preferably, 35-65 wt %, based on the total washcoat loading of the inlet catalyst layer.

The inlet OSC material loading in the inlet catalyst layer can be less than 2 g/in³. In some embodiments, the inlet OSC material loading in the inlet catalyst layer is no greater than 1.5 g/in³, 1.2 g/in³, 1.0 g/in³, 0.8 g/in³, 0.7 g/in³, or 0.6 g/in³.

In some embodiments, the inlet alkali or alkali earth metal may be deposited on the inlet OSC material (e.g., the first and/or the second). Alternatively, or in addition, the inlet alkali or alkali earth metal may be deposited on the inlet inorganic oxide. That is, in some embodiments, the inlet alkali or alkali earth metal may be deposited on, i.e., present on, both the inlet OSC material and the inlet inorganic oxide.

Preferably the inlet alkali or alkali earth metal is supported/deposited on the inlet inorganic oxide (e.g., alumina). In addition to, or alternatively to, being in contact with the inlet inorganic oxide, the inlet alkali or alkali earth metal may be in contact with the inlet OSC material and also the inlet Pt and/or Rh component.

The inlet alkali or alkali earth metal is preferably barium or strontium. Preferably the barium or strontium, where present, is present in an amount of 0.1 to 15 weight percent, and more preferably 3 to 10 weight percent barium, based on the total weight of the inlet catalyst layer.

Preferably the barium is present as a BaCO₃ composite material. Such a material can be performed by any method known in the art, for example incipient wetness impregnation or spray-drying.

The inlet inorganic oxide is preferably an oxide of Groups 2, 3, 4, 5, 13 and 14 elements. The inlet inorganic oxide is preferably selected from the group consisting of alumina, magnesia, lanthana, silica, titania, niobia, tantalum oxides, molybdenum oxides, tungsten oxides, and mixed oxides or composite oxides thereof. Particularly preferably, the outlet inorganic oxide is alumina, a lanthanum/alumina composite oxide, or a magnesia/alumina composite oxide. One especially preferred inlet inorganic oxide is a lanthanum/alumina composite oxide or a magnesia/alumina composite oxide. The inlet inorganic oxide may be a support material for the inlet palladium component, and/or for the inlet alkali or alkali earth metal.

Preferred inlet inorganic oxides preferably have a fresh surface area of greater than 80 m²/g, pore volumes in the range 0.1 to 4 mL/g. High surface area inorganic oxides having a surface area greater than 100 m²/g are particularly preferred, e.g. high surface area alumina. Other preferred inlet inorganic oxides include lanthanum/alumina composite oxides, optionally further comprising a cerium-containing component, e.g., ceria. In such cases the ceria may be present on the surface of the lanthanum/alumina composite oxide, e.g., as a coating.

The inlet OSC material and the inlet inorganic oxide can have a weight ratio of no greater than 10:1, preferably, no greater than 8:1 or 5:1, more preferably, no greater than 4:1 or 3:1, most preferably, no greater than 2:1.

Alternatively, the inlet OSC material and the inlet inorganic oxide can have a weight ratio of 10:1 to 1:10, preferably, 8:1 to 1:8 or 5:1 to 1:5; more preferably, 4:1 to 1:4 or 3:1 to 1:3; and most preferably, 2:1 to 1:2.

The outlet catalyst layer can be essentially free of PGM metals other than the outlet rhodium component.

The outlet catalyst layer can comprise 1-40 g/ft³ of the outlet rhodium component. Preferably, the outlet catalyst layer can comprise 3-20 g/ft³, more preferably, 4-15 g/ft³ of the outlet rhodium component.

The outlet catalyst layer may further comprise an outlet PGM component. In some embodiments, the outlet PGM component is palladium, platinum, or a mixture thereof. In further embodiments, the outlet PGM component is platinum.

When the outlet platinum component is present, the outlet catalyst layer can comprise up to 100 g/ft³ of the outlet platinum component. Preferably, the outlet catalyst layer can comprise 1-80 g/ft³, more preferably, 5-50 g/ft³ of the outlet platinum component. In some embodiments, the platinum loading in the inlet catalyst layer can be no less than the platinum loading in the outlet catalyst layer. The ratio of the inlet platinum component and the outlet platinum component can be from 50:1 to 1:1, preferably from 40:1 to 3:2, more preferably, 30:1 to 2:1. In other embodiments, the platinum loading in the inlet catalyst layer is greater than the platinum loading in the outlet catalyst layer. The ratio of the inlet platinum component and the outlet platinum component can be at least 3:2, preferably at least 2:1, more preferably, at least 3:1.

When the outlet platinum component is present, the weight ratio of the outlet platinum component to the outlet rhodium component can be from 10:1 to 1:10 or 5:1 to 1:5, preferred, 3:1 to 1:3, more preferably, 2:1 to 1:2. Alternatively, the weight ratio of the outlet platinum component to the outlet rhodium component can be at least 1:5, preferred, at least 1:3, more preferably, at least 1:2.

The overall PGM loading in the inlet catalyst layer can be greater than the overall PGM loading in the outlet catalyst layer. In some embodiments, the ratio of the overall PGM loading in the inlet catalyst layer and the overall PGM loading in the outlet catalyst layer can be at least 1:1, preferably, at least 3:2. In certain embodiments, the ratio of the overall PGM loading in the inlet catalyst layer and the overall PGM loading in the outlet catalyst layer can be at least 2:1. In further embodiments, the ratio of the overall PGM loading in the inlet catalyst layer and the overall PGM loading in the outlet catalyst layer can be at least 10:1, 20:1 or 30:1.

The total washcoat loading of the outlet catalyst layer can be 0.1 to 3.5 g/in³. Preferably, the total washcoat loading of the outlet catalyst layer is 0.5 to 3 g/in³, most preferably, the total washcoat loading of the outlet catalyst layer is 0.6 to 2.5 g/in³.

The outlet catalyst layer can further comprise a first outlet oxygen storage capacity (OSC) material, an outlet alkali or alkali earth metal component, and/or an outlet inorganic oxide.

The first outlet OSC material is preferably selected from the group consisting of cerium oxide, zirconium oxide, a ceria-zirconia mixed oxide, and an alumina-ceria-zirconia mixed oxide. More preferably, the first outlet OSC material comprises the ceria-zirconia mixed oxide. The ceria-zirconia mixed oxide can further comprise some dopants, such as, La, Nd, Y, Pr, etc.

The ceria-zirconia mixed oxide can have a molar ratio of zirconia to ceria at least 50:50, preferably, higher than 60:40, more preferably, higher than 80:20. In addition, the first outlet OSC material may function as a support material for the outlet rhodium component.

Alternatively, the ceria-zirconia mixed oxide can have a molar ratio of zirconia to ceria from 20:1 to 1:20. In some embodiments, the ceria-zirconia mixed oxide can have a molar ratio of zirconia to ceria from 10:1 to 1:10. In further embodiments, the ceria-zirconia mixed oxide can have a molar ratio of zirconia to ceria from 5:1 to 1:1.

The outlet catalyst layer can further comprise a second outlet OSC material.

The second outlet OSC material is preferably selected from the group consisting of cerium oxide, zirconium oxide, a ceria-zirconia mixed oxide, and an alumina-ceria-zirconia mixed oxide. More preferably, the second outlet OSC material comprises the ceria-zirconia mixed oxide. The ceria-zirconia mixed oxide can further comprise some dopants, such as, La, Nd, Y, Pr, etc.

The outlet OSC material, including the first and the second, can be from 10 to 90 wt %, preferably, 25-75 wt %, more preferably, 35-65 wt %, based on the total washcoat loading of the outlet catalyst layer.

The outlet OSC material loading in the outlet catalyst layer can be less than 2 g/in³. In some embodiments, the outlet OSC material loading in the outlet catalyst layer is no greater than 1.5 g/in³, 1.2 g/in³, 1.1 g/in³, or 1.0 g/in³.

The outlet alkali or alkali earth metal is preferably barium or strontium. Preferably the barium or strontium, where present, is present in an amount of 0.1 to 15 weight percent, and more preferably 3 to 10 weight percent barium, based on the total weight of the outlet catalyst layer.

Preferably the barium is present as a BaCO₃ composite material. Such a material can be performed by any method known in the art, for example incipient wetness impregnation or spray-drying.

In some embodiments, the outlet catalyst layer can be substantially free of the outlet alkali or alkali earth metal. In further embodiments, the outlet catalyst layer can be essentially free of the outlet alkali or alkali earth metal.

The outlet inorganic oxide is preferably an oxide of Groups 2, 3, 4, 5, 13 and 14 elements. The outlet inorganic oxide is preferably selected from the group consisting of alumina, magnesia, lanthanum, silica, titania, niobia, tantalum oxides, molybdenum oxides, tungsten oxides, and mixed oxides or composite oxides thereof. Particularly preferably, the outlet inorganic oxide is alumina, a lanthanum/alumina composite oxide, or a magnesia/alumina composite oxide. One especially preferred outlet inorganic oxide is a lanthana/alumina composite oxide or a magnesia/alumina or a zirconium/alumina composite oxide. The outlet inorganic oxide may be a support material for the outlet rhodium component.

The outlet OSC material and the outlet inorganic oxide can have a weight ratio of no greater than 10:1, preferably, no greater than 8:1 or 5:1, more preferably, no greater than 4:1, most preferably, no greater than 3:1.

Alternatively, the outlet OSC material and the outlet inorganic oxide can have a weight ratio of 10:1 to 1:10, preferably, 8:1 to 1:8 or 5:1 to 1:5; more preferably, 4:1 to 1:4; and most preferably, 3:1 to 1:3.

The catalyst article of the present invention can further comprise additional layers or zones. In some embodiments, the catalyst article of the present invention does not further comprise additional layers or zones.

The catalyst article of the invention may comprise further components that are known to the skilled person. For example, the compositions of the invention may further comprise at least one binder and/or at least one surfactant. Where a binder is present, dispersible alumina binders are preferred.

Preferably the substrate is a flow-through monolith, or wall flow gasoline particulate filter. More preferably, the substrate is a flow-through monolith.

The flow-through monolith substrate has a first face and a second face defining a longitudinal direction there between. The flow-through monolith substrate has a plurality of channels extending between the first face and the second face. The plurality of channels extend in the longitudinal direction and provide a plurality of inner surfaces (e.g. the surfaces of the walls defining each channel). Each of the plurality of channels has an opening at the first face and an opening at the second face. For the avoidance of doubt, the flow-through monolith substrate is not a wall flow filter.

The first face is typically at an inlet end of the substrate and the second face is at an outlet end of the substrate.

The channels may be of a constant width and each plurality of channels may have a uniform channel width.

Preferably within a plane orthogonal to the longitudinal direction, the monolith substrate has from 100 to 900 channels per square inch, preferably from 300 to 750. For example, on the first face, the density of open first channels and closed second channels is from 300 to 750 channels per square inch. The channels can have cross sections that are rectangular, square, circular, oval, triangular, hexagonal, or other polygonal shapes.

The monolith substrate acts as a support for holding catalytic material. Suitable materials for forming the monolith substrate include ceramic-like materials such as cordierite, silicon carbide, silicon nitride, zirconia, mullite, spodumene, alumina-silica magnesia or zirconium silicate, or of porous, refractory metal. Such materials and their use in the manufacture of porous monolith substrates is well known in the art.

It should be noted that the flow-through monolith substrate described herein is a single component (i.e. a single brick). Nonetheless, when forming an emission treatment system, the monolith used may be formed by adhering together a plurality of channels or by adhering together a plurality of smaller monoliths as described herein. Such techniques are well known in the art, as well as suitable casings and configurations of the emission treatment system.

In embodiments wherein the catalyst article of the present comprises a ceramic substrate, the ceramic substrate may be made of any suitable refractory material, e.g., alumina, silica, titania, ceria, zirconia, magnesia, zeolites, silicon nitride, silicon carbide, zirconium silicates, magnesium silicates, aluminosilicates and metallo aluminosilicates (such as cordierite and spodumene), or a mixture or mixed oxide of any two or more thereof. Cordierite, a magnesium aluminosilicate, and silicon carbide are particularly preferred.

In embodiments wherein the catalyst article of the present invention comprises a metallic substrate, the metallic substrate may be made of any suitable metal, and in particular heat-resistant metals and metal alloys such as titanium and stainless steel as well as ferritic alloys containing iron, nickel, chromium, and/or aluminum in addition to other trace metals.

As shown in FIG. 1, the inlet catalyst layer is fully supported/deposited directly on the substrate. The outlet catalyst layer is partially supported/deposited directly on the substrate and partially supported/deposited on the top of the inlet catalyst layer. Thus, the middle zone comprises both the inlet catalyst layer and the outlet catalyst layer.

As shown in FIG. 2, the outlet catalyst layer is fully supported/deposited directly on the substrate. The inlet catalyst layer is partially supported/deposited directly on the substrate and partially supported/deposited on the top of the outlet catalyst layer. Thus, the middle zone comprises both the outlet catalyst layer and the inlet catalyst layer.

Another aspect of the present disclosure is directed to a method for treating a vehicular exhaust gas containing NOₓ, CO, and HC using the catalyst article described herein. Catalytic converters equipped with TWC made according to the invention not only show improved or comparable catalytic performance compared to conventional TWC, but also show a significant improvement in backpressure (e.g., see Examples 1 and 2 and Tables 1 and 2).

Another aspect of the present disclosure is directed to a system for treating vehicular exhaust gas comprising the catalyst article described herein in conjunction with a conduit for transferring the exhaust gas through the system.

### Definitions

The term “washcoat” is well known in the art and refers to an adherent coating that is applied to a substrate usually during production of a catalyst.

The acronym “PGM” as used herein refers to “platinum group metal”. The term “platinum group metal” generally refers to a metal selected from the group consisting of Ru, Rh, Pd, Os, Ir and Pt, preferably a metal selected from the group consisting of Ru, Rh, Pd, Ir and Pt. In general, the term “PGM” preferably refers to a metal selected from the group consisting of Rh, Pt and Pd.

The term “mixed oxide” as used herein generally refers to a mixture of oxides in a single phase, as is conventionally known in the art. The term “composite oxide” as used herein generally refers to a composition of oxides having more than one phase, as is conventionally known in the art.

The expression “consist essentially” as used herein limits the scope of a feature to include the specified materials, and any other materials or steps that do not materially affect the basic characteristics of that feature, such as for example minor impurities. The expression “consist essentially of” embraces the expression “consisting of”.

The expression “substantially free of” as used herein with reference to a material, typically in the context of the content of a region, a layer or a zone, means that the material in a minor amount, such as ≤5% by weight, preferably ≤2% by weight, more preferably ≤1% by weight. The expression “substantially free of” embraces the expression “does not comprise.”

The expression “essentially free of” as used herein with reference to a material, typically in the context of the content of a region, a layer or a zone, means that the material in a trace amount, such as ≤1% by weight, preferably ≤0.5% by weight, more preferably ≤0.1% by weight. The expression “essentially free of” embraces the expression “does not comprise.”

Any reference to an amount of dopant, particularly a total amount, expressed as a % by weight as used herein refers to the weight of the support material or the refractory metal oxide thereof.

The term “loading” as used herein refers to a measurement in units of g/ft³ on a metal weight basis.

The term “a” or “an”, as used herein, is defined as one or as more than one.

The following examples merely illustrate the invention. Those skilled in the art will recognize many variations that are within the spirit of the invention and scope of the claims.

### Examples

### Materials

All materials are commercially available and were obtained from known suppliers, unless noted otherwise.

### Catalyst 1 (Comparative)

Catalyst 1 is a commercial three-way (Pd—Rh) catalyst with a uniform double-layered structure (e.g., as shown in FIG. 3). The bottom layer consists of Pd supported on a washcoat of a first CeZr mixed oxide, La-stabilized alumina, Ba promotor. The washcoat loading of the bottom layer was about 2.5 g/in³ with a Pd loading of 32 g/ft³. The top layer consists of Rh supported on a washcoat of a second CeZr mixed oxide, La-stabilized alumina. The washcoat lading of the top layer was about 1.8 g/in³ with a Rh loading of 11 g/ft³. The total washcoat loading of Catalyst 1 was about 4.3 g/in³.

### Catalyst 2

Catalyst 2 was prepared according to the present invention. The layer consists of Rh supported on a washcoat of a first CeZr mixed oxide, a second CeZr mixed oxide, La-stabilized alumina, Pt particles, Pd particles and Ba promotor. The washcoat loading of the layer was about 3 g/in³ with Pt/Pd/Rh loadings of 8/12/11 g/ft³.

The final slurry of the layer was coated from the inlet and outlet faces of the same substrate as Comparative Catalyst 1 using standard coating procedures with coating depth targeted of 66% of the substrate length, dried at 70° C. The brick was calcined at 500° C. for 30 mins.

### Catalyst 3 (Comparative)

Catalyst 3 is a commercial three-way (Pt—Pd—Rh) catalyst with a zoned double-layered structure (e.g., as shown in FIG. 3). The bottom layer consists of Pd supported on a washcoat of a first CeZr mixed oxide, La-stabilized alumina, Ba promotor. The washcoat loading of the bottom layer was about 2.9 g/in³. The front half is at a Pd loading of 161.3 g/ft³ and the rear half is at a Pd loading of 55.0 g/ft³. The top layer consists of Pt and Rh supported on a washcoat of a second CeZr mixed oxide, La-stabilized alumina. The washcoat lading of the top layer was about 1.8 g/in³. The front half is at Pt and Rh loadings of 9.5 and 19.0 g/ft³, respectively, and the rear half is at Pt and Rh loadings of 4.6 and 9.2 g/ft³, respectively. The total washcoat loading of Catalyst 1 was about 4.7 g/in³.

### Catalyst 4

Catalyst 4 was prepared according to the present invention. The layer consists of Rh supported on a washcoat of a first CeZr mixed oxide, a second CeZr mixed oxide, La-stabilized alumina, Pt particles and Ba promotor. The washcoat loading of the layer was about 2.8 g/in³ with Pt/Rh loadings of 120.7 and 19 g/ft³ at the front half, respectively and of 71.2 and 9.2 g/ft³ at the rear half, respectively.

The final slurry of the layer was coated from the inlet and outlet faces of the same substrate as Comparative Catalyst 3 using standard coating procedures with coating depth targeted of 66% of the substrate length, dried at 70° C. The brick was calcined at 500° C. for 30 mins.

### EXPERIMENTAL RESULTS

### Example 1

Comparative Catalyst 1 and Catalyst 2 were bench aged for 75 hours with a mode aging cycle, with a peak temperature at 1000° C. Catalytic performances were evaluated by a commercial 2.4 litre engine bench. The so-called “light-off” temperatures at which conversions of reactant reach at 50% were measured.

TABLE 1
Catalysts Performance by Engine Bench Analysis

| | Light off | | |
|---|---|---|---|
| | temperature (° C.) | | |
| | HC | CO | NOₓ |
| Comparative Catalyst 1 | 342 | 336 | 330 |
| Catalyst 2 | 338 | 329 | 326 |

As shown in Table 1, Catalyst 2 showed comparable or even improved catalyst performances, even with a lower total washcoat loading (about 70%) as well as a lower PGM contents (about 70%) than Comparative Catalyst 1.

### Example 2

Comparative Catalyst 3 and Catalyst 4 were bench aged for 150 hours with a mode aging cycle, with a peak temperature at 1000° C. Catalytic performances were evaluated by a commercial 2.4 litre engine bench. The so-called “Air to fuel ratio” sweep test collecting the conversions of reactant at a temperature of 600° C. was performed.

TABLE 2
Catalysts Performance by Engine Bench Analysis

| | Conversions (%) at a temperature of 600° C. | | | | | | | | |
|---|---|---|---|---|---|---|---|---|---|
| | HC | | | CO | | | NOₓ | | |
| | A/F | A/F | A/F | A/F | A/F | A/F | A/F | A/F | A/F |
| | 14 | 14.5 | 15 | 14 | 14.5 | 15 | 14 | 14.5 | 15 |
| Comparative Catalyst 3 | 65.3 | 96.7 | 88.3 | 4.7 | 99.6 | 99.2 | 93.2 | 98.5 | 0 |
| Catalyst 4 | 70.7 | 97.8 | 90.1 | 4.7 | 99.6 | 99.2 | 93.3 | 97.4 | 0 |

As shown in Table 2, Catalyst 4 showed comparable or even improved catalyst performances in particular to HC conversion, even with a lower total washcoat loading (about 60%) than Comparative Catalyst 4.

1. A catalyst article for treating exhaust gas comprising:
a substrate comprising an inlet end, an outlet end with an axial length L;
an inlet catalyst layer beginning at the inlet end and extending for less than the axial length L, wherein the inlet catalyst layer comprises an inlet rhodium component and an inlet platinum component;
an outlet catalyst layer beginning at the outlet end and extending for less than the axial length L, wherein the outlet catalyst layer comprises an outlet rhodium component.

2. The catalyst article of claim 1, wherein the rhodium loading in the inlet catalyst layer is no less than the rhodium loading in the outlet catalyst layer.

3. The catalyst article of claim 2, wherein the overall PGM loading in the inlet catalyst layer is greater than the overall PGM loading in the outlet catalyst layer.

4. The catalyst article of claim 1, wherein the inlet catalyst layer extends for 20 to 90 percent of the axial length L.

5. The catalyst article of claim 1, wherein the outlet catalyst layer extends for 20 to 90 percent of the axial length L.

6. The catalyst article of claim 1, wherein the total length of the outlet catalyst layer and the inlet catalyst layer is from 90 percent to 180 percent of the axial length L.

7. The catalyst article of claim 1 wherein the ratio of the inlet rhodium component and the outlet rhodium component is from 20:1 to 1:1.

8. The catalyst article of claim 7, wherein the ratio of the inlet rhodium component and the outlet rhodium component is from 10:1 to 3:2.

9. The catalyst article of claim 1, wherein the inlet catalyst layer further comprises an inlet PGM component.

10. The catalyst article of claim 9, wherein the inlet PGM component is palladium.

11. The catalyst article of claim 10, wherein the weight ratio of the inlet palladium component to the inlet rhodium component is from 100:1 to 1:10.

12. The catalyst article of claim 1, wherein the inlet catalyst layer further comprises a first inlet oxygen storage capacity (OSC) material, an inlet alkali or alkali earth metal component, and/or an inlet inorganic oxide.

13-19. (canceled)

20. The catalyst article of claim 1, wherein the outlet catalyst layer further comprises an outlet PGM component.

21. The catalyst article of claim 20, wherein the outlet PGM component is palladium, platinum, or a mixture thereof.

22. The catalyst article of claim 21, wherein the outlet PGM component is platinum.

23. The catalyst article of claim 22, wherein the ratio of the inlet platinum component and the outlet platinum component is from 50:1 to 1:1.

24. The catalyst article of claim 22, wherein the weight ratio of the outlet platinum component and the outlet rhodium component is from 10:1 to 1:10.

25. The catalyst article of claim 1, wherein the outlet catalyst layer further comprises a first outlet oxygen storage capacity (OSC) material, an outlet alkali or alkali earth metal component, and/or an outlet inorganic oxide.

26-34. (canceled)

35. The catalyst article of claim 1, wherein the inlet catalyst layer is supported/deposited directly on the substrate.

36. The catalyst article of claim 1, wherein the outlet catalyst layer is supported/deposited directly on the substrate.

37. (canceled)

38. (canceled)
